(19) United States
(12) Patent Application Publication
(10) Pub. No.: US 2017/0146325 A1
(43) Pub. Date: May 25, 2017

(54) LINE CHARGE

(71) Applicant: ELECTROMECHANICA, INC., Mattapoisett, MA (US)

(72) Inventors: Karl Reid Edminster, Fairhaven, MA (US); Andrew Phillip DeMedeiros, Fall River, MA (US); Stephen Armand Piché, North Easton, MA (US); Adam Carl Robert, Douglas, MA (US)

(21) Appl. No.: 14/945,872

(22) Filed: Nov. 19, 2015

(51) Int. Cl. F42B 3/087; B64C 39/02; F42B 3/24

(52) U.S. Cl. CPC F42B 3/087; F42B 3/24; B64C 39/024; B64C 2201/128

(57) ABSTRACT

A line charge includes a thin plastic tube that is deployed by a mechanical means. The thin plastic tube is filled with an explosive material after deployment to form a line charge suitable for route clearance or demolitions.

### BACKGROUND

1. Field of Disclosure

Aspects and embodiments of the present disclosure are directed generally to line charge systems for route clearance and demolitions.

2. Discussion of Related Art

Projected line charges are used in military applications for route clearance and to demolitions. During WWII a British-made, rocket-deployed, flexible line charge called the “Conger” was developed. The Conger was the first modern mine clearing line charge. The Conger was a woven 2-inch diameter flexible hose launched across a minefield by a rocket. After the hose was deployed, it was filled with liquid explosive. The system was unreliable and dangerous due to the sensitive nature of the explosive fluid used.

In a typical modern application a linear charge of explosive material, typically plasticized explosive, is projected into an operational area by a rocket or similar device. The rocket pulls the line charge out of a canister and deploys it in roughly a straight line. The line charge flies through the air then lands on the ground where it is subsequently detonated. Detonating the charge clears obstacles such as razor wire and improvised explosive devices (IEDs). Projected line charges such as the Man Portable Line Charge (MPLC®) or Anti-Personnel Obstacle Breaching System (APOBS) may be utilized by dismounted soldiers. For longer route clearing the M58 Mine Clearing Line Charge (MICLIC) may be employed.

All existing projected line charge systems project the line charge containing the explosive. This requires that the entire mass of the explosive and its packaging be launched through the air for deployment. This typically requires the use of rockets as deployment means which add cost, complexity and mass to the system. Additionally, a hazard exists should deployment fail and live explosives are projected incorrectly as the charge cannot be easily recalled once deployed. These systems also require substantial deployment and setup time before use. The setup requires multiple steps that are prone to operator error. The systems contain explosives which require expensive and labor intensive compliance with complicated regulations for acquisition, transportation, and storage.

Existing line charge systems are deployed by unguided rockets. This limits deployment to a straight line and requires the line charge to be lifted high above the ground to allow full extension before landing back on the ground. The charge is prone to being blown off target by wind or becoming entangled in trees, power lines or other structures. Existing systems can only be deployed where there is a clear, to straight line area for deployment. Additionally, existing systems have no means for controlling deployment distance or quantity of the line charge. Existing line charges can only be deployed in their entirety, which often limits deployment where shorter lengths or non-straight line deployment would be advantageous for limiting collateral damage.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic illustration of an embodiment of a line charge system including an unmanned aerial vehicle for deploying a line charge;

FIG. 2 is a schematic illustration of another embodiment of a line charge system including an unmanned aerial vehicle for deploying a line charge;

FIG. 3 is a schematic illustration of another embodiment of a line charge system including an unmanned aerial vehicle for deploying a line charge;

FIG. 4A illustrates an example of a method of packaging a line charge tube prior to deployment;

FIG. 4B illustrates another example of a method of packaging a line charge tube prior to deployment;

FIG. 5 is a schematic illustration of an embodiment of a line charge system including a projected mass for deploying a line charge;

FIG. 6 is a schematic illustration of another embodiment of a line charge system including a projected mass for deploying a line charge;

FIG. 7 illustrates an embodiment of an apparatus for dispensing an explosive material into a line charge tube;

FIG. 8 illustrates explosive material as it is being dispensed into an embodiment of a line charge tube;

FIG. 9 illustrates explosive material as it is being dispensed into another embodiment of a line charge tube;

FIG. 10 illustrates another embodiment of an apparatus for dispensing an explosive material into a line charge tube; and

FIG. 11 illustrates an embodiment of a line charge tube filled with an explosive material and coupled to an initiator cap.

### SUMMARY

In accordance with an aspect disclosed herein there is provided a line charge system. The system comprises a thin plastic tube having a distal end and a proximal end and forming a container for a line charge, mechanical means for deploying the plastic tube, a vent defined in the distal end of the plastic tube, and a plug configured to travel through the tube from the proximal end to the distal end upon introduction of a fluid explosive into the proximal end of the tube subsequent to deploying the plastic tube and to seal the vent upon reaching the distal end of the plastic tube.

In some embodiments, the mechanical means includes a mass coupled to the distal end of the plastic tube and means for projecting the mass a distance through the air, projection of the mass through the air deploying the plastic tube. The mechanical means may include a pyrotechnic device for launching or projecting the mass.

In some embodiments, the system further comprises a mechanical projection device for projecting the mass.

In some embodiments, the system further comprises a controller configured to remotely actuate the projection device, to fill the tube with the liquid explosive, and to initiate detonation of the liquid explosive.

In some embodiments, the mechanical means includes an unmanned aerial vehicle (UAV).

In some embodiments, the system is configured to deploy the plastic tube along a curved path.

In some embodiments, the system further comprises a deployment container in which the thin plastic tube is z-folded prior to deployment.

In some embodiments, the system further comprises a deployment container including a roller upon which the thin plastic tube is rolled prior to deployment.

In some embodiments, the plug is configured to displace air ahead of the plug through the vent as the plug travels through the plastic tube.

In some embodiments, the system further comprises a container housing the fluid explosive prior to the fluid explosive being introduced into the plastic tube. The fluid explosive may be a binary explosive including binary components and the container may include a first sub-container for a first of the binary components and a second sub-container for a second of the binary components. The system may further include a mixing chamber configured to mix the binary components of the binary explosive. The mixing chamber may be configured to mix the binary components of the binary explosive while the binary explosive is being dispensed into the plastic tube.

In some embodiments, the line charge system does not contain materials classified as explosives per ATF Publication 5400.8 or Title 49 CFR 172.101 Hazardous Materials Table during transportation and storage and prior to mixing of the binary components of the binary explosive. The line charge contains a material classified as explosives per ATF Publication 5400.8 or Title 49 CFR 172.101 Hazardous Materials Table once the binary components are mixed.

In some embodiments, the system further comprises an initiator (cap) well integrated into the plastic tube to provide ignition of the liquid explosive.

In accordance with another aspect, there is provided a line charge system comprising a thin plastic tube having a distal end and a proximal end and forming a container for a line charge, mechanical means for deploying the plastic tube, a liquid explosive dispenser configured to couple to the proximal end of the plastic tube and dispense the liquid explosive into the plastic tube, and a valve at the distal end of the plastic tube that will allow air to pass out of the plastic tube but retain the liquid explosive inside the plastic tube.

In accordance with another aspect, there is provided a method for deploying a line charge. The method comprises providing a line charge system. The line charge system includes a thin plastic tube having a distal end and a proximal end and forming a container for the line charge, mechanical means for deploying the plastic tube; a vent defined in the distal end of the plastic tube, and a plug configured to travel through the tube from the proximal end to the distal end upon introduction of a fluid explosive into the proximal end of the tube subsequent to deploying the plastic tube and to seal the vent upon reaching the distal end of the plastic tube. The method further comprises deploying the plastic tube with the mechanical means and introducing the fluid explosive into the plastic tube.

In some embodiments, deploying the plastic tube with the mechanical means includes deploying the plastic tube with an unmanned vehicle.

In some embodiments, deploying the plastic tube with the mechanical means includes deploying the plastic tube with a projected mass coupled to the distal end of the plastic tube.

### DETAILED DESCRIPTION

Aspects and embodiments disclosed herein are not limited to the details of construction and the arrangement of components set forth in the following description or illustrated in the drawings. Aspects and embodiments disclosed herein are capable of other embodiments and of being practiced or of being carried out in various ways.

Aspects and embodiments described herein provide distinct advantages over existing projected line charge systems. Embodiments of line charge systems disclosed herein may be substantially lighter in weight than existing systems and are thus more easily transportable and operable than previously known systems. In some embodiments, the disclosed line charge systems utilize a binary explosive which is not explosive (and not classified as an explosive) until the binary components are mixed. The components of the binary explosive may be mixed in the field at a point of use and may be introduced into a line charge tube or conduit after deployment of the line charge tube or conduit. Embodiments of the line charge system thus do not include any explosive components until the line charge system is deployed in the field, rendering transportation and storage of the line charge system safer and less restrictive. As the terms are used herein, an explosive material, a material classified as an explosive, and an explosive component include materials listed in “List of Explosive Materials” (ATF Publication 5400.8) and listed in the Federal Register Vol. 80, No. 205, Friday, Oct. 23, 2015 beginning on page 64446, or which the U.S. Department of Transportation has designated as hazardous materials for purposes of transportation, listed in the Hazardous Materials Table in Title 49 CFR 172.101 (as amended by 66 FR 45379, Aug. 28, 2001).

In one embodiment, a line charge system includes an empty thin flattened plastic tube. The empty thin flattened plastic tube may be efficiently packed by z-folding, rolling, or by other compact packaging methods into a container, for example, a box, thus taking up little space prior to deployment. The materials of construction of the thin flattened plastic tube are not particularly limited, and may include one or more of, for example, polystyrene, polyethylene, polypropylene, nylon, polyamide, polyolefin, polytetrafluoroethylene, or polyvinylidene fluoride. In addition to a polymeric material forming walls of the line charge tube, some embodiments of the line charge tube may include reinforcing material, for example, fabric or polymeric fibers embedded in or secured to the walls of the line charge tube. In some embodiments, the line charge tube may be multilayered and/or reinforced. The line charge tube may be constructed from multiple layers of polymeric material, for example, with a liner, a braided fabric reinforcement layer, and/or an overmolding layer to help protect the line charge tube from damage. The line charge tube may include a composite structure with an inner tube, a reinforcing braid or yarn layer (including, for example, one or more of Kevlar®, Spectra®, Dyneema® fibers, glass fibers, carbon fibers, and/or another super fiber) and an abrasion/sunlight resistant (possibly camouflaged) outer layer. In another embodiment, the line charge tube may include coaxial tubes where the smaller explosive tube is in the center or near the bottom and the larger tube is filled with water to form a jacket. This water jacket may act as a tamper or reaction mass to direct energy into an object opposite the water.

Embodiments of the line charge tube include a closable distal end. A vent is provided in the closable distal end to allow gas, for example, air to leave the line charge tube as the line charge tube is filled with explosive, as is explained in further detail below. The line charge tube includes a proximal end that is open and which is to configured to allow an explosive, for example, a liquid explosive mixture, to be introduced into the line charge tube.

The line charge tube may have a diameter of between about 0.5 inches (about 1.3 cm) and about four inches (about 10.2 cm), a wall thickness of between about 10 mils (about 245 μm) and about 40 mils (about 1,016 μm), and a length of between about 25 feet (about 7.6 meters) and about 300 feet (about 91.4 meters). It is to be understood that these dimensions are only exemplary and different embodiments may have different dimensions suitable to a particular implementation. In some embodiments, the line charge tube is constructed of light weight materials so that the line charge tube has a mass of between about five and about ten grams per foot (between about 16.4 grams and about 32.8 grams per meter). Although referred to herein as a tube, the line charge tube may have cross sectional areas other than circular, for example, oval, substantially triangular, substantially square, substantially rectangular, or other cross sectional areas that may be appropriate for a particular implementation.

In accordance with various aspects and embodiments, a line charge tube is deployed utilizing one or more mechanical means. As the term is used herein, “mechanical means” are distinct from means utilizing one or more rockets to deploy a line charge tube.

In some embodiments, a mass is coupled to the first end of the line charge tube (the distal end) or proximate the first end of the line charge tube. In some embodiments, the mass is coupled to the end of the line charge tube via a tether, line, or lanyard having a first end coupled to the mass and a second end coupled to the line charge tube. The line charge tube may include a reinforced grommet or other connecting member that provides a connection between the line charge tube and the tether, line, or lanyard. In other embodiments, the mass may be secured directly to, or formed integral with, the first end of the line charge tube or proximate the first end of the line charge tube. The mass is sufficiently large that projection of the mass will cause the attached line charge tube to be dragged behind the mass, out of its z-folded or otherwise packed configuration from its storage container, if a storage container is used, and into an extended deployed position. The weight of the mass may vary to based on the projection length and total mass of the line charge tube and the method used to project the mass and the velocity at which the mass is projected. In one example, the mass has a weight of between about 0.1 kg and 1 kg. In some embodiments, the mass is in the form of a metal ball. In other embodiments, the mass may be formed in any shape and from any material that has sufficient density to deploy the line charge tube upon projection of the mass.

The mass is projected either by a launch mechanism including mechanical means such as springs or compressed gas or by a pyrotechnic charge such as a blank shell. Motive force for projecting the mass is, in some embodiments, provided by a stationary launch mechanism that is either mounted on the ground or hand held. The line charge tube is of sufficiently low mass that a rocket is not required for deployment. As the projected mass is launched through the air it pulls the z-folded thin plastic line charge tube and deploys it much like a conventional line charge. Significantly less force is required to be exerted by the projected mass to deploy the thin plastic line charge tube as compared to known line charges due to the low mass of the plastic line charge tube. In some embodiments, the position of the deployed line charge tube is evaluated prior to filling with explosive mixture. If the line charge tube did not deploy in a desirable location, it may be discarded or recovered, and another line charge tube may be deployed. In some embodiments, the mass may be thrown by hand; mechanical or pyrotechnic projection energy may not be required.

In some embodiments, a shock absorbing system may be provided to reduce the chance of mechanical damage to the line charge tube upon deployment. In some embodiments, an elastic or plastically deformable member, for example, a rubber or plastic cable or tether is connected at a first end to the line charge tube proximate or at the distal or proximal end of the line charge tube. The elastic or plastically deformable member may include a second end that is fixed to the ground proximate the launch mechanism or to the launch mechanism itself. Upon deployment of the line charge tube, kinetic energy remaining after the entire line charge tube has been extended into a deployed configuration may be absorbed and/or dissipated by the elastic or plastically deformable member to reduce chances of mechanical damage, for example, tears or ruptures to the line charge tube due to forces experienced by the line charge tube during deployment.

In another embodiment, the thin plastic line charge tube is deployed by a vehicle. In some embodiments the vehicle is an airborne craft, for example, an unmanned aerial vehicle (UAV). One example of a suitable type of UAV is a quadcopter. In some embodiments, the UAV is remote controlled, for example, by commands sent by a radio frequency transmitter or by electrical signals sent through an electrical connection between the UAV and a controller. The skilled artisan will understand that there are numerous other known methods of remote control of an airborne vehicle, and the present disclosure is not limited to any particular one of these methods. In other embodiments, the UAV is preprogrammed to follow a predetermined flight path for deploying the thin plastic line charge tube. In some embodiments, the UAV includes a camera to provide images of the thin plastic line charge tube as it is being deployed or after deployment to an operator to facilitate control of the UAV to deploy the thin plastic line charge tube in a desired location or pattern or to illustrate the deployed thin plastic line charge tube to the operator so the operator can determine if the thin plastic line charge tube has been properly deployed.

In embodiments utilizing a UAV to deploy the thin plastic line charge tube, deployment is not limited to deployment in a straight line by the ballistic trajectory of a projected mass. The UAV can dispense or deploy the thin plastic line charge tube in any commanded pattern/path. In some embodiments, utilizing a UAV to deploy the thin plastic line charge tube provides for much greater control over position of the dispensed tube than if the tube were deployed utilizing a projected mass. As discussed above, the UAV may provide real time visual (and other) feedback of the dispensing path, which is something that prior known systems and methods of dispensing line charge tubes could not do. With a UAV, dispensing or deployment of the thin plastic line charge tube can occur close to the ground as elevation is not needed as is with a ballistic mass. This may have advantages, for example, presenting a lower signature, reducing the likelihood that the dispensing of the line charge tube might be observed by enemy combatants or others from whom it may be desirable to conceal deployment of the line charge tube. Deployment of the line charge tube close to ground may also provide for reduced displacement of the tube by wind. In some to embodiments, the UAV may be able to reposition a previously deployed line charge tube. In other embodiments, the UAV can maneuver to place charges on vertical surfaces or structures for breaching/demolitions.

In another embodiment the line charge tube is deployed from an unmanned ground vehicle (UGV) or unmanned underwater vehicle (UUV). The tube may be carried and played out, actively or passively, from a container on the vehicle, a container at a base point, or both. The vehicle will allow an operator to remotely deploy the tube and will allow controlled, non-straight line deployment as desired. Cameras on the vehicle may provide a high level of situational awareness and observation of the deployment path.

Once the thin plastic line charge tube is properly deployed it is filled with a liquid, gel, emulsion, or slurry explosive mixture from an explosive mixture dispenser. The explosive mixture dispenser includes, in some embodiments, a pressurized container and/or a pump attached at the opposite end of the line charge tube (a proximal end) from the projection mass or from the end of the tube that was carried in to place by the vehicle. In some embodiments, the explosive mixture dispenser includes a mixer configured to mix components of a binary explosive on site at a location of deployment of the line charge system. The components of the binary explosive may be mixed upon dispensing the components of the binary explosive into the line charge tube. The mixer may include, for example, a venturi device which draws one component of the binary explosive into the venturi as another component of the binary explosive is passed through the venturi, thus mixing the two components. In other embodiments, a mixer separate from the explosive mixture dispenser may be utilized and the mixed explosive mixture transferred to the explosive mixture dispenser after mixing.

Pressure or pumping action applied by the explosive mixture dispenser forces the explosive fluid from a reservoir in the explosive mixture dispenser into the thin plastic line charge tube. A plug is located in the tube and acts like a piston moving down the length of the tube from the force of the pressurized liquid. In some embodiments, the plug is inserted into the line charge tube during manufacture. In other embodiments, the plug may be inserted by an operator into the line charge tube to while preparing the line charge tube for deployment. The plug is dimensioned such that it substantially blocks flow of explosive mixture around sides of the plug and into portions of the line charge tube on an opposite side of the plug from the explosive mixture dispenser. The plug may be substantially spherical, cylindrical, or bullet shaped and may be formed from, for example, plastic, rubber, or foam. The size, shape, and material(s) of construction of the plug may be selected as desired for a particular implementation.

As the plug travels down the line charge tube it displaces any air in the line charge tube out the vent located near the projected first end. When the plug reaches the vent it seals the vent to prevent explosive mixture from escaping the tube. The proximal end of the line charge tube attached to the explosive mixture dispenser may then be detached from the explosive mixture dispenser and sealed. Alternatively, the explosive mixture dispenser may remain attached to the explosive filled line charge tube and may be consumed by the detonation of the explosive. In some embodiments, the proximal end of the line charge tube may be fitted with a self-sealing ‘quick connect’ type fitting commonly used in general fluid systems. In some embodiments, explosive mixture dispenser includes a cap well where the initiator (blasting cap) for initiating detonation of the explosive is placed.

Many types of liquid, gel, emulsion or slurry explosives may be used. One example of a liquid explosive which may be utilized with embodiments of the line charge system disclosed herein is described in U.S. Pat. No. 6,960,267, “MULTI-COMPONENT LIQUID EXPLOSIVE COMPOSITION AND METHOD” which is incorporated herein by reference. Binary agents may be particularly well suited as the components are not explosives until mixed. This would allow the entire assembly to be classified as flammable rather than explosive for storage and transportation. Only when the binary components are mixed as they enter the tube would they become explosives. The Helix™ binary explosive product manufactured by Omni Distribution may be particularly well suited for the explosive filler.

After the line charge tube is filled with a desired amount of the explosive mixture, the line charge may be detonated by initiating detonation of the explosive mixture. Detonation of the explosive mixture may be initiated with a blasting cap to disposed in a cap well formed at or proximate the proximal end of the line charge tube. In some embodiments, an explosive booster, for example, a sleeve of PETN or other plastic explosive may be used to increase the power of the blasting cap to more reliably initiate detonation of the explosive mixture in the line charge tube.

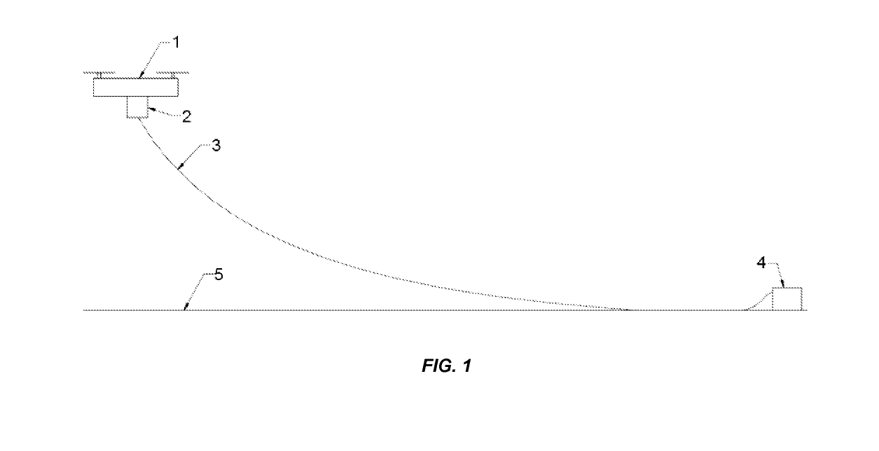

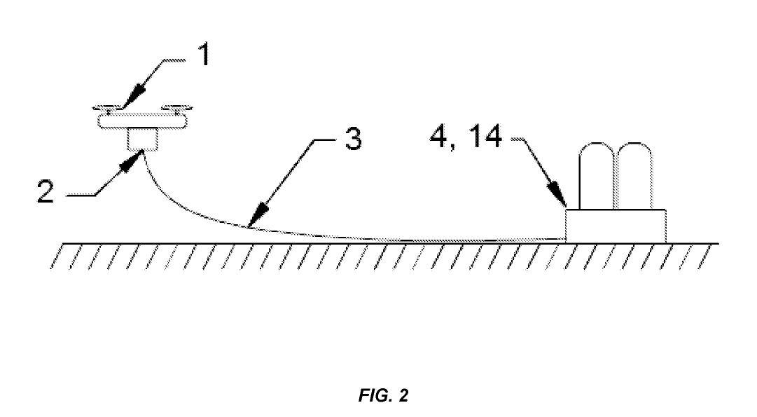

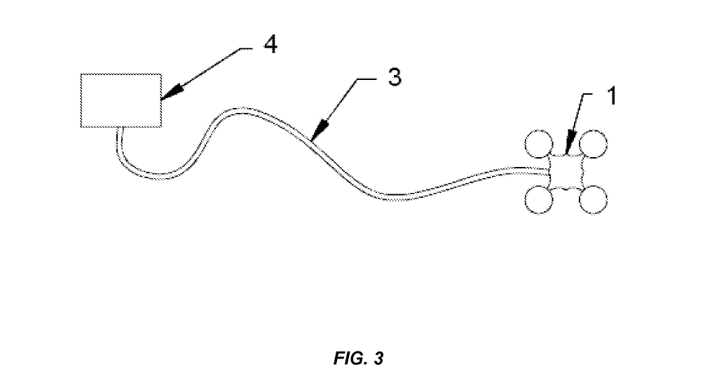

An embodiment of a line charge system as disclosed herein is illustrated in FIG. 1. FIG. 1 illustrates a UAV 1 deploying a line charge tube 3 onto the ground 5 from a dispenser 2 disposed on the UAV. The UAV 1 travels generally away from a base point 4 while deploying the line charge tube 3. In some embodiments, as illustrated in FIG. 2, an explosive reservoir 14 is located at the base point 4 and explosive material is introduced into a proximal end of the line charge tube at the base point 4. In an alternate embodiment, the dispenser 2 is located at or proximate the base point 4 and the UAV 1 releasably carries a distal end of the line charge tube 3, pulling additional length of the line charge tube 3 from the dispenser 2 as is moves away from the base point 4. In other embodiments, the UAV 1 may carry a proximal end of the line charge tube 3 and/or the dispenser 2. The UAV 1 may dispense the line charge tube 3 until a desired length of line charge tube 3 has been dispensed. The desired length may be less than a total length of line charge tube 3 provided in the dispenser 2. In some embodiments, the UAV 1 may be utilized to deploy the line charge tube in a non-linear curved path, as illustrated in FIG. 3. Known line charge deployment systems do not have this capability.

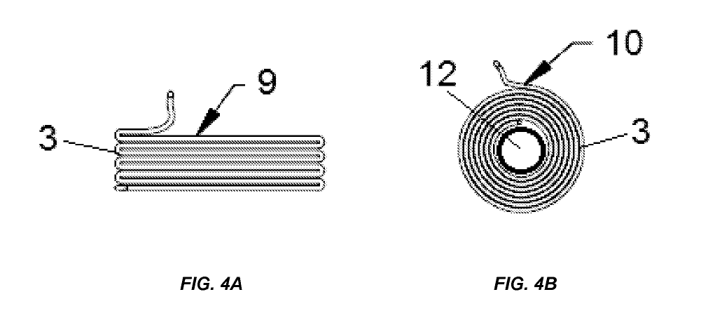

The dispenser 2 may include a box or a roller upon or within which the to-be-deployed line charge tube had previously been packaged. For example, as illustrated in FIG. 4A, the line charge tube 3 may be packaged as a flattened tube that is Z-folded into a folded configuration 9 and packaged in a dispenser prior to deployment. In an alternative embodiment, as illustrated in FIG. 4B, the line charge tube 3 may be packaged as a flattened tube that is rolled about a spindle or roller 12 and packaged in a dispenser prior to deployment.

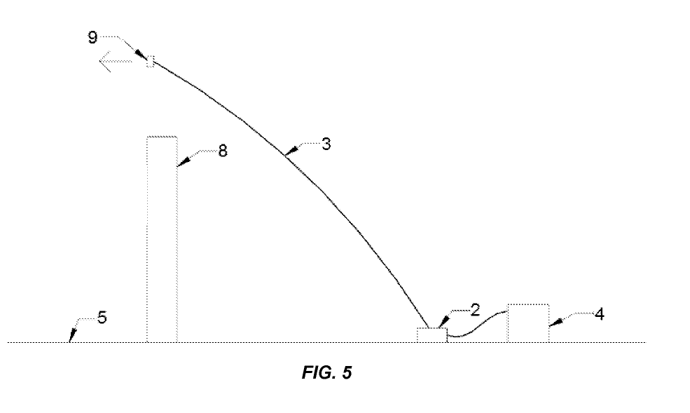

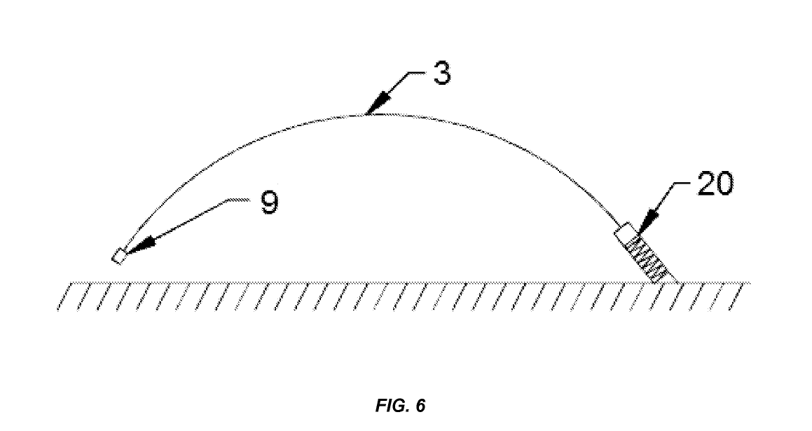

FIG. 5 illustrates an embodiment of a line charge tube 3 being deployed with the use of a projected mass 9. In the embodiment illustrated in FIG. 5, a mass 9 is coupled to a distal end of the line charge tube 3. The mass 9 is projected from an area proximate the tube dispenser 2 by a mechanical means, for example, by a catapult or other mechanical projection system, for example, mechanical projection system 20 illustrated in FIG. 6. As the mass 9 flies away from the tube dispenser, additional line charge tubing 3 is pulled from the tube dispenser 2. The mechanical projection system may be utilized to project the mass 9 and a portion of the line charge tube 3 onto a portion of the ground 5 by projecting the mass 9 and portion of line charge tube 3 over a wall 8 or other barrier. Once deployed, the line charge tube 3 is filled with explosive mixture from the explosive reservoir 4, which may be located at a base point along with the tube dispenser 2.

In some embodiments, the mechanical projection system 20 includes a catapult or other projection system utilizing a compressed spring or other compressible member to project the mass 9 from the projection system 20. In other embodiments, the projection system 20 may utilize pyrotechnics, for example, an explosive charge to project the mass 9 from the projection system 20. In some embodiments, the projection system 20 may be similar to a mortar launcher, cannon, or rifle grenade launcher. In other embodiments, mechanisms similar to decoy launchers for training hunting dogs or line throwing guns used in ship operations may be utilized in the projection system 20 to project the mass 9.

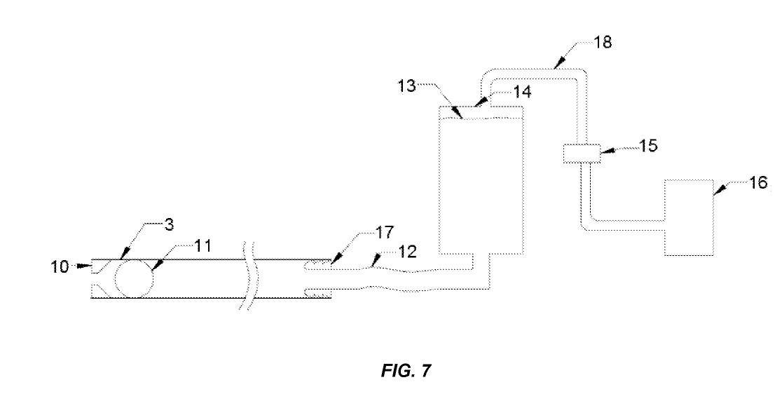

FIG. 7 illustrates a system and method for dispensing explosive mixture into a deployed line charge tube 3. In the embodiment illustrated in FIG. 7, explosive mixture 13 is provided in a reservoir 14. Pressure is provided to the interior of the reservoir from a pressurized gas source 16 under control of a filling valve 15 through pressure tube 18. Explosive mixture is expelled from the reservoir 14 under the influence of the applied pressure and travels via a fill tube 12 into the line charge tube 3. A fitting 17 couples the fill tube 12 to the proximal end of the line charge tube 3 and may include a check valve that ensures explosive mixture dispensed into the line charge tube 3 does not leak back out the proximal end. As the explosive mixture is dispensed into the line charge tube, it displaces a plug 11 along a length of the line charge tube 3. Air is expelled from the venting plug 10 at the distal end of the line charge tube 3 by the displacement of the plug 11. Upon reaching the venting plug 10, the plug 11 forms a seal against the venting plug 10, preventing explosive mixture from leaking from the distal end.

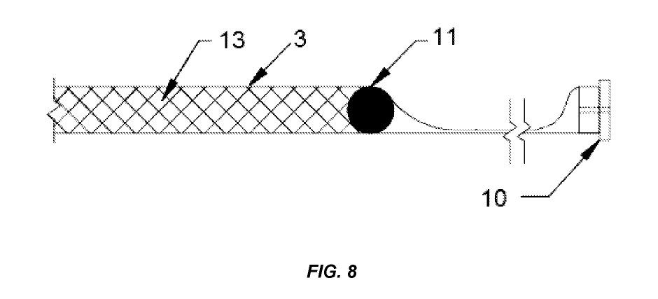

FIG. 7 illustrates a pressurized gas reservoir 16 for providing pressure to force the explosive mixture 13 from the reservoir 14. In other embodiments, one or more pumps may be utilized to push or pull explosive mixture from the reservoir 14. FIG. 8 illustrates that as the explosive mixture 13 is pumped or otherwise introduced into the line charge tube, the plug 11 may be displace along the length of the line charge tube, opening up previously flattened or folded portions of the tube as the plug advances toward the venting plug 10.

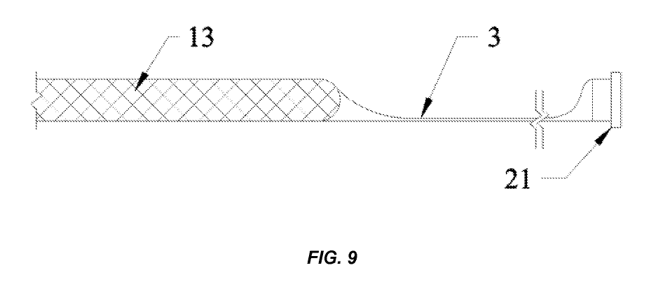

In another embodiment, illustrated in FIG. 9, the plug 11 may be omitted. In the embodiment of FIG. 9, the line charge tube 3 includes a vent 21 that allows air trapped within the line charge tube 3 to be expelled as the line charge tube 3 is filled with the liquid explosive 13. The vent 21 prevents viscous material, for example, the liquid explosive 13 from passing out of the line charge tube. In some embodiments, a small amount of the liquid explosive 13 may leak through the vent 21. In some embodiments, the vent 21 may include a gas permeable membrane, for example a Tyvek® fiber membrane, a Gore-Tex® fiber membrane, or any other membrane or vent that allows the passage of air but resists the passage of viscous liquids through the membrane.

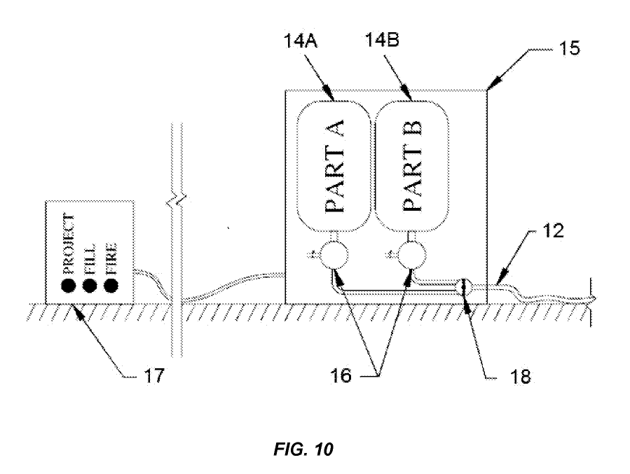

FIG. 7 illustrates the explosive 13 as a single body of material, however, in other embodiments, the explosive 13 is a binary explosive that is mixed only upon being dispensed into the line charge tube 3. For example, as illustrated in FIG. 10, an explosive material dispenser 15 may include two separate reservoirs 14A and 14B for different components of a binary explosive. The components of the binary explosive may be pumped from the reservoirs 14A, 14B by pumps 16 that may be operated under the control of a controller 17, which may also control deployment of the line charge tube 3 and detonation of the explosive material 13. In some embodiments, the components of the binary explosive pass through a valve, venturi, or mixing chamber 18 for mixing as they are introduced into the fill tube 12 or directly into the line charge tube 3.

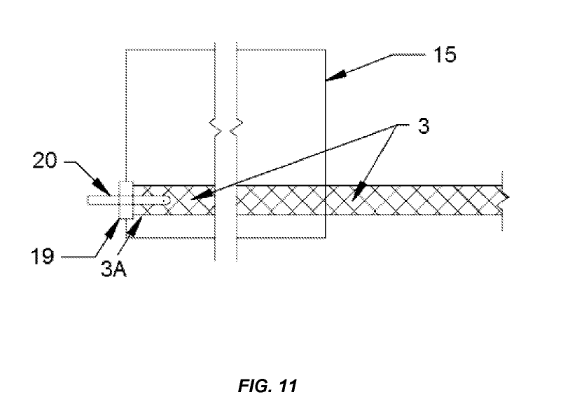

In some embodiments, the explosive material 13, after being dispensed into the line charge tube 3 is detonated using an initiator cap 19 that is held in place in the line charge tube 3, for example, the proximal end 3A of the line charge tube 3 by a well 20 as illustrated in FIG. 11. In some embodiments, the well 20 is prefabricated in the line charge tube 3. In other embodiments, the well 20 is inserted into the line charge tube 3 just prior to or after dispensing the explosive material 13 into the line charge tube 3. In other embodiments, the well 20 may be pre-fabricated into the fill tube 12 or into the explosive material dispenser 15.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the disclosure. One or more features of any one embodiment disclosed herein may be combined with or substituted for one or more features of any other embodiment disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A line charge system comprising:
a thin plastic tube having a distal end and a proximal end and forming a container for a line charge;
an unmanned aerial vehicle (UAV) including a dispenser for deploying the plastic tube;
a vent defined in the distal end of the plastic tube; and
a plug configured to travel through the tube from the proximal end to the distal end upon introduction of a fluid explosive into the proximal end of the tube subsequent to deploying the plastic tube and to seal the vent upon reaching the distal end of the plastic tube.

2-4. (canceled)

5. The line charge system of claim 1, further comprising a controller configured to remotely fill the tube with the liquid explosive, and to initiate detonation of the liquid explosive.

6. (canceled)

7. The line charge system of claim 1, configured to deploy the plastic tube along a curved path.

8. The line charge system of claim 1, wherein the dispenser includes a deployment container in which the thin plastic tube is z-folded prior to deployment.

9. The line charge system of claim 1, wherein the dispenser includes a deployment container including a roller upon which the thin plastic tube is rolled prior to deployment.

10. The line charge system of claim 1, wherein the plug is configured to displace air ahead of the plug through the vent as the plug travels through the plastic tube.

11. The line charge system of claim 1, further comprising a container housing the fluid explosive prior to the fluid explosive being introduced into the plastic tube.

12. The line charge system of claim 11, wherein the fluid explosive is a binary explosive including binary components and the container includes a first sub-container for a first of the binary components and a second sub-container for a second of the binary components.

13. The line charge system of claim 12, further comprising a mixing chamber configured to mix the binary components of the binary explosive.

14. The line charge system of claim 13, wherein the mixing chamber is configured to mix the binary components of the binary explosive while the binary explosive is being dispensed into the plastic tube.

15. The line charge system of claim 12, wherein the line charge system does not contain materials classified as explosives per one of ATF Publication 5400.8 and Title 49 CFR 172.101 Hazardous Materials Table during transportation and storage and prior to mixing of the binary components of the binary explosive.

16. The line charge system of claim 15, wherein the line charge contains a material classified as explosives per one of ATF Publication 5400.8 and Title 49 CFR 172.101 Hazardous Materials Table once the binary components are mixed.

17. The line charge system of claim 1, further comprising an initiator (cap) well integrated into the plastic tube to provide ignition of the liquid explosive.

18. A line charge system comprising:
a thin plastic tube having a distal end and a proximal end and forming a container for a line charge;
an unmanned aerial vehicle (UAV) including a dispenser for deploying the plastic tube;
a liquid explosive dispenser configured to couple to the proximal end of the plastic tube and dispense the liquid explosive into the plastic tube; and
a valve at the distal end of the plastic tube that will allow air to pass out of the plastic tube but retain the liquid explosive inside the plastic tube.

19. A method for deploying a line charge, the method comprising:
providing a line charge system including:
a thin plastic tube having a distal end and a proximal end and forming a container for the line charge;
an unmanned aerial vehicle (UAV) including a dispenser for deploying the plastic tube;
a vent defined in the distal end of the plastic tube; and
a plug configured to travel through the tube from the proximal end to the distal end upon introduction of a fluid explosive into the proximal end of the tube subsequent to deploying the plastic tube and to seal the vent upon reaching the distal end of the plastic tube;
deploying the plastic tube from the dispenser with the mechanical means; and
introducing the fluid explosive into the plastic tube.

20. (canceled)

21. (canceled)

22. The line charge system of claim 1, wherein the plastic tube is multilayered.

23. The line charge system of claim 22, wherein the plastic tube includes a first tube configured to receive the fluid explosive and a second tube disposed around the first tube and configured to be filled with water, the water in the second tube acting as a tamper to direct energy into an object upon detonation of the fluid explosive.

24. The line charge system of claim 1, wherein the plastic tube includes reinforcing fibers.

25. The line charge system of claim 1, wherein the plastic tube has a mass of between about 16.4 grams per meter and 32.8 grams per meter.

26. The line charge system of claim 1, wherein the UAV is a rotary-wing UAV.

27. The line charge system of claim 1, wherein the UAV includes a camera configured to provide images of the plastic tube to an operator of the UAV as the plastic tube is being deployed.
